(19) United States
(12) Patent Application Publication
(10) Pub. No.: US 2024/0116241 A1
(43) Pub. Date: Apr. 11, 2024

(54) Additive Manufacturing Methods and Systems For Attaching Embellishments to Materials and Associated Items

(71) Applicant: Avery Dennison Retail Information Services LLC, Mentor, OH (US)

(72) Inventors: James J. DEININGER, Highland Heights, OH (US); Christopher MAIO, Wickliffe, OH (US); Pramod K. SHARMA, Ann Arbor, MI (US); Shawn P. ROBERTS, South Euclid, OH (US); Danielle L. KRAMER, Mentor, OH (US); Michelle PEARCE, Chardon, OH (US)

(21) Appl. No.: 17/768,553

(22) PCT Filed: Oct. 16, 2020
(86) PCT No.: PCT/US2020/056058

§ 371 Date: Apr. 13, 2022

Related U.S. Application Data
(60) Provisional application No. 62/915,919, filed on Oct. 16, 2019.

(51) Int. Cl. B29C 64/153; B29C 64/245; B29C 64/268; B29C 64/393; B33Y 10/00; B33Y 50/02

(52) U.S. Cl. CPC B29C 64/153; B29C 64/245; B29C 64/268; B29C 64/393; B33Y 10/00; B33Y 50/02

(57) ABSTRACT

In some embodiments, a method of manufacturing includes forming and attaching a first embellishment part onto a substrate composing a clothing article by sintering a thermoplastic powder on the substrate. Sintering may occur at a temperature below a temperature threshold, and sintering may further occur at a pressure below a pressure threshold. The first embellishment part may include all structural components of an entire embellishment. The first embellishment part may be a foundation for a complete embellishment. The method may also include forming a second embellishment part using an additive manufacturing process.

### CROSS-REFERENCE TO RELATED APPLICATION

The present application claims the benefit of U.S. Provisional Patent Application No. 62/915,919 filed Oct. 16, 2019, which is incorporated herein by reference in its entirety.

### BACKGROUND

The present disclosure relates generally to the production or attachment of external embellishments such as a brand names, logos, or decorations. In some conventional systems, attaching an external embellishment to certain materials requires the use of stitching, sonic welding, or thermal bonding, each of which come with associated limitations such as added cost, need for additional time, or additional complication. Accordingly, a need exists for improved methods for attaching or forming embellishments and creating associated items.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

In some embodiments, a method of manufacturing includes forming and attaching a first embellishment part onto a substrate composing a clothing article by sintering a thermoplastic powder on the substrate. Sintering may occur at a temperature below a temperature threshold, and sintering may further occur at a pressure below a pressure threshold.

In some embodiments, an additively manufactured embellished article includes a substrate composing a clothing article, and a first embellishment part formed and attached to the substrate by sintering a thermoplastic powder on the substrate. Sintering may have occurred at a temperature below a temperature threshold, and sintering may have occurred at a pressure below a pressure threshold.

In some embodiments, a method of optimizing print conditions for a plurality of external embellishments includes mixing a thermoplastic powder with an additive to form a mixture. The method further includes sintering the mixture to additively manufacture a test bed matrix of the plurality of external embellishments. The method also includes analyzing each of the plurality of external embellishments and determining an optimal print position within the test bed matrix.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a top view of one configuration of an external embellishment, in accordance with some embodiments.

FIG. 2 illustrates a top view of a second configuration of an external embellishment, in accordance with some embodiments.

FIG. 3 illustrates a side view of a thickness of a first portion of the second configuration of the external embellishment, in accordance with some embodiments.

FIG. 4 illustrates a side view of a thickness of a second portion of the second configuration of the external embellishment, in accordance with some embodiments.

FIG. 5 illustrates a perspective view of a test bed matrix, in accordance with some embodiments.

FIG. 6 illustrates an overhead view of the test bed matrix, in accordance with some embodiments.

FIG. 7 is an illustration of an embellished article, in accordance with some embodiments.

FIG. 8 is an illustration of another embellished article, in accordance with some embodiments.

### DETAILED DESCRIPTION

The following description is provided with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, various structures and devices are shown in block diagram form in order to facilitate a description thereof.

Some embodiments of this disclosure include manufacturing processes that allow for directly manufacturing and/or attaching external embellishments to items that previously would have utilized stitching, sonic welding, or thermal bonding as an attachment mechanism. By avoiding such attachment mechanisms, manufacturing or assembly of embellished articles may be simplified, made cheaper, and/or increased in speed or accuracy. In other embodiments, such methods may also be used to enhance or otherwise improve attachment of an embellishment.

External embellishments are implements commonly used to decorate, adorn and/or to label items and materials. As can readily be appreciated, external embellishments are desirably resistant to wear, wash, abrasion and chemical effects in order to avoid a loss of information, visual effect, and/or quality, and desirably possess good adhesion to the articles and items to which they are affixed. In some embodiments, embellishments are formed to have a 3D features, such as one or more raised or lowered areas. The external embellishments or identifiers produced by various embodiments of the methods of the present disclosure can advantageously be applied or attached to various goods or materials to produce enhanced appearance and clarity, official-looking quality, higher end luxury, and combinations thereof.

Materials that embellishments may be attached to include fabrics, foam, paper, cardboard, plastic, wood, metal, brick, and other materials. Items being embellished may include transfer labels, patches, tags, or identification placards. Embellishments may include logos, trademarks, numeric identifiers, alphabetic identifiers, alphanumeric identifiers, symbols, decorative artwork, and the like. Items that embellishments may be attached to may include garments and clothing articles, such as bodywear, headwear, footwear, outerwear, underwear, garments, sheet goods, flags, uniforms, backpacks, soft luggage, gloves, hats, scarves, glasses, wristbands, necklaces, jackets, pants, facemasks, socks, sandals, boots, shoes, combinations thereof, and associated accessories. Other items that embellishments may be attached to include watches, bags, wallets, purses, boxes, books, pads, tools, gifts, balls, toys, and other items. External embellishments produced by the methods of some embodiments may be bondable to any type of cloth or fabric material, and may also be in the form of additively printable appliqué emblems.

In various embodiments, some external embellishments may be manufactured by additive manufacturing processes such as, Stereolithography (SLA), Fused Deposition Modeling (FDM), PolyJetting, Continuous Liquid Interface (CLI), and the like. In various embodiments, external embellishments may be formed from thermoplastics onto fabrics or other soft and/or porous goods.

### Selective Laser Sintering (SLS)

In some embodiments, SLS is used to additively manufacture one or more external embellishments and/or a support or other parts for an external embellishment.

By way of background, selective laser sintering (SLS) is an additive manufacturing technique that utilizes a laser to sinter or fuse a powder material into a solid structure. More specifically, the laser is aimed at points in space defined by a 3D model to manufacture a final product from the powder material. SLS printing utilizes a 3D printer to print the product, such as from a powderized material like a thermoplastic powder. SLS may have an advantage over some other additive manufacturing techniques, in part because a range of thermoplastic and specialty polymers may be utilized in the process. Other 3D printing technologies, such as Stereolithography, may be limited to printing with UV-LED curable thermoset materials, which may result in products that are more brittle than items formed from thermoplastics. Additionally, SLS may not require any support structures because the powderized powder may be able to support the parts during the printing process allowing one to create parts with complicated geometries and greater resolution compared to other thermoplastic or thermoset technologies, such as Fused Deposition Modeling, PolyJetting, or Continuous Liquid Interface. These additional technologies may also be used in various embodiments.

In some embodiments, a 3D printing machine may be used in connection with the methods of the present disclosure. For example, a 3D printing machine that may be used is the Lisa Pro 3D SLS printer manufactured by Sinterit of Krakow, Poland. The Lisa Pro 3D SLS printer may employ a λ 808 nm IR laser. Other 3D printing machines can also be used without affecting the overall concept of the present disclosure. For example, exemplary laser sintering printers may operate at wavelengths of 532 nm, 1.06 μm, or 10.6 μm, or have capabilities for printing at temperatures up to 220° C., or up to 280° C. Some embodiments may use a laser capable of operating at up to 5-8 W, 12 W, 30 W, 50 W, 80 W, 100 W, 120 W, 140 W, or 160 W.

For some embodiments, before printing a powderized plastic, the powder may be sieved to increase the number of particles with the correct particle sizes to be used during the 3D printing process. More specifically, the pre-process sieving of the plastic powder may reduce or eliminate the number of large clumps that could affect the resolution or quality of the resulting print. For various embodiments, after the powder is pre-processed, the powder may be loaded into the printer, may be leveled, and may be heated close to the melting point onset temperature. For example, polyamide melts at between 178-180° C. according to differential scanning colorimetry (DSC) analysis. Therefore, the print chamber could be preheated to between the onset temperature (173° C.) and the melting temperature (180° C.), such as to achieve efficient sintering. For some embodiments, this technique may be applied to find the most efficient printing temperature when attempting to print with custom powder formulations.

Once the printed parts (e.g., external embellishments) are complete and the printing chamber cools below 50° C., the parts may be removed from the print chamber and post-processed. More specifically, the parts may be cleaned by blasting air and/or glass beads on all surfaces to remove any unsintered powder therefrom by the process of abrasion. However, care must still be employed during post-processing to avoid breaking or creating defects in the printed part.

### Testing

Experimentation was initially conducted to obtain information regarding the Lisa Pro printer for a variety of low-temperature thermoplastics in connection with various methods of the present disclosure, which are described below. More specifically, the National Institute of Standards and Technology (NIST) Additive Manufacturing Test Artifact or coupon was printed in four different sizes ranging from 1 inch to 0.3 inches, and the top surface was analyzed for any defects using a photobooth. The NIST artifact has several measurable features on its surface to allow for the testing of a printer's ability to print complicated features, the maximum printing resolution, and other properties to create a standard. Experimentation noted that the size of the coupon did not directly determine whether a certain feature could be printed, thereby indicating that bed position, part orientation, laser power, and temperature could have a large effect on printing certain features. However, the larger parts tended to have more defined features than the smaller parts during the experimentation. Microscopy was used to obtain quantitative measurements from coupon-to-coupon or condition-to-condition.

Post printing, some parts were dipped in an UV-LED ink and allowed to soak for approximately two minutes in an attempt to add surface color with custom ABIS UV-LED CMKY+W inks manufactured by Avery Dennison of Glendale, California. After soaking, the printed parts were LED cured (395 nm, 20 W/cm²) for approximately 10 seconds. This post printing technique illustrates one possible method of producing colored parts for external embellishments.

Next, custom low-temperature thermoplastic powders were investigated. Rowak-35-N manufactured by Rowak AG of Switzerland is a semi-flexible polyurethane-based thermoplastic used in external embellishments, such as, but not limited to, Agility™ and Agility-IQ™ both manufactured by Avery Dennison, for adhesion to substrates such as cotton and polyester. As SLS uses temperatures that are close to the melting temperature of a polymer, a complete understanding of the phase transitions (i.e. melting point, glass transition) of the specific thermoplastic is important. Differential scanning calorimetry (DSC) was used to measure the various phase transitions.

In one test, the DSC data from TAQ-2000 (25-200° C. at 5° C./minute) determined that the melting temperature of Rowak-35-N powder is approximately 121° C., and that the crystallization temperature is approximately 102° C. after cooling. Additionally, there was a peak in the reading upon heating to around 60° C., which indicates a phase transition likely due to an additive in the Rowak-35-N powder. Experiments conducted at 119° C. and 117° C. completely sintered the entire powder bed of Rowak-35-N powder, thereby indicating that the temperature ranges were too high to produce specific parts. As the temperature decreased to 117° C., the test bed still sintered, but was more flexible and brittle.

A factor in laser sintering is the type of laser used. In this case, the Lisa Pro printer used employs a laser with a wavelength of approximately 800 nm (near-infrared) to sinter parts. The Rowak-35-N powder is white in color, and may have difficulty absorbing 800 nm radiation, which is why the testing did not produce printed parts even at temperature ranges between the crystallization and melting points. To overcome this problem, 2%, 10%, and 20% of Nylon-12 black powder was added to the Rowak-35-N powder, and parts were able to be sintered. As the Nylon-12 powder content increased, so did the accuracy and resolution of the printed part. More specifically, no parts were able to be created through the laser sintering process when the Nylon-12 powder content was 0%. At 2% Nylon-12 powder content, a semi-sintered part was obtained, and at 10%, a part with greater structural integrity and resolution was created. The addition of Nylon-12 powder is likely non-linear in terms of structural integrity, accuracy, and resolution, and the Nylon-12 powder likely has a graphene or graphite additive allowing for the absorption of the 800 nm laser. Thus, graphite powder (less than 2 microns) was determined to be a potential printing additive for Rowak based thermoplastics.

The Lisa SLS printer was also utilized to print parts having different Rowak based thermoplastic powders that generally have high flexibility as they are polyurethane in nature. In order to investigate the need to mix white powders, such as thermoplastics, with a material that can absorb a laser wavelength of approximately 800 nm, graphite powder (carbon) was added to the powders and tested at different concentrations (0.13%-10%). At high concentrations of graphite, the printed material or part tended to be more brittle. By comparison, at lower concentrations, the printed parts tended to be more flexible. At concentrations above 10% and below 1%, the low-temperature thermoplastic powder did not sinter properly, thereby leading to parts not being printed properly or having low structural integrity.

Next, Rowak-33-80 powder having a particle size of 80 microns and below was tested. When used at carbon additive concentrations of 2% and 0.5%, the printed parts failed after printing. Next Rowak-35-80 powder was printed at the same conditions, and the parts again failed after printing. However, when the same Rowak-35-80 powder was printed at a print bed temperature of 115° C., instead of 119° C., the print quality greatly improved. This demonstrates that as the particle size of the Rowak-35-80 powder changes, the temperature of the test bed may also be adjusted and it is contemplated that smaller sized particles absorb heat more efficiently when mixed at the same concentration of carbon additive. Accordingly, for some embodiments, as smaller particles are used, the temperature may be decreased. As larger particles are used, the temperature may be increased.

### Manufacturing

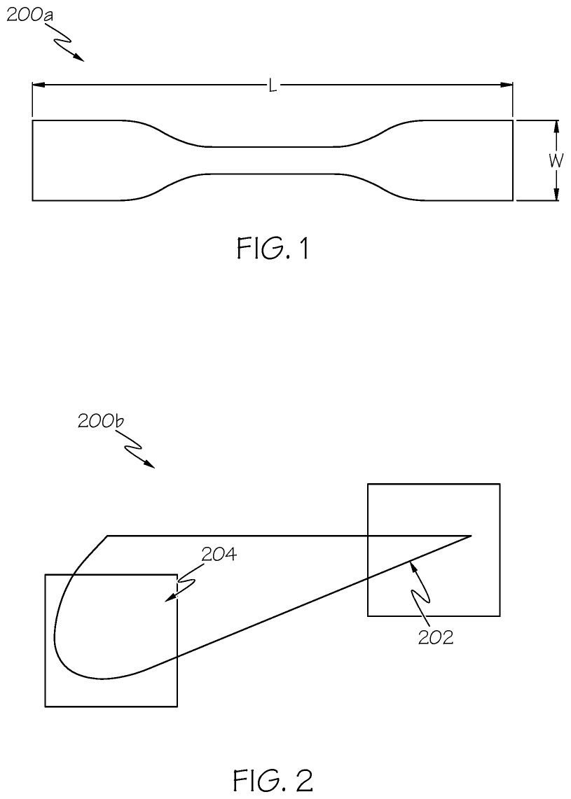

Referring initially to the drawings, FIGS. 1-8 illustrate the output of various methods for manufacturing part or all of an external embellishment 200a or 200b (collectively referred to as embellishment 200), in accordance with some embodiments of the present disclosure. Embellishment 200 may be directly bondable using additive manufacturing to a substrate such as a fabric material for a garment, a soft good, items produced using additive manufacturing methods, or other materials. A part of an external embellishment 200 that may be formed includes a foundation for attaching other embellishments that may otherwise require more limited or difficult methods for bonding or attaching components. Also disclosed are methods of optimizing printing conditions for the external embellishments that utilize a more efficient printing process and that result in more properly formed external embellishments. Parts created through additive manufacturing processes may have the advantage of eliminating a number of production steps, such as screen printing, that are commonly associated with other manufacturing techniques. The additive manufacturing process allows for the direct manufacturing of parts and products through a variety of 3D printing technologies. In particular, SLS may be used to sinter or fuse powders to form external embellishments 200 layer by layer, and that are directly bondable to fabric with low pressure and heat.

One of ordinary skill in the art will appreciate that the shape, size, configuration and contents of the plurality of external embellishments 200 shown in FIGS. 1 and 2 are for illustrative purposes only, and that many other shapes, sizes, configurations and graphical contents of the external embellishments 200 are well within the scope of the present disclosure. Although the dimensions of the external embellishments 200 (i.e., length, width, and height) are important design parameters for good performance, the external embellishments 200 may be any shape or size that ensures optimal performance during use. Some examples of external embellishments 200 may include numerical indicia, alphabetical indicia, alphanumeric indicia, a logo, an insignia, a geometric shape, a non-geometric shape, or combinations thereof.

In some embodiments, the method of manufacturing an external embellishment of the present disclosure begins by selecting a thermoplastic powder. In various embodiments, a low-temperature thermoplastic powder is used. Some examples include a polyurethane, a polyamide, polystyrenes (PS), thermoplastic elastomers (TPE), polyaryletherketones (PAEK), or a polycarbonate. Examples include Rowak-33, Rowak-34, Rowak-200-7, or similar powders or mixtures of the same. Other types of plastic powders may be used to form part or all of an embellishment, including one or more of acrylic (e.g., polymethyl methacrylate [PMMA]), ABS, nylon, PLA, polybenzimidazole, polyether sulfone, polyoxymethylene, polyetherimide, polyethylene, polyphenylene oxide, polyphenylene sulfide, polypropylene, polystyrene, polyvinyl chloride, polyvinylidene fluoride, polytetrafluoroethylene (teflon). Other materials that may be used may include small particles of metal, ceramic, or glass. In various embodiments, the plastic powder includes recycled plastics, such as from plastic recovered from the ocean, and/or from plastic bottles, bags, toys, or other products.

Given that some thermoplastic powders cannot absorb or may have limited ability to absorb 800 nm infrared rays or other wavelengths, the thermoplastic powder may then be mixed with an additive that is selected to permit proper sintering of the mixture. For example, the additive may be capable of absorbing infrared rays at a wavelength of at least between 795-815 nm. In various embodiments, the thermoplastic powder is a low temperature thermoplastic powder.

For various embodiments, the additive may consist of approximately between 0.5-10% of the mixture by weight, and may include graphite or carbon black. Other concentrations may include between 0.5-1%, 1-2%, 2-3%, 3-4%, 4-5%, 5-6%, 6-7%, 7-8%, 8-9%, 9-10%, 10-12%, 12-18%, or 18-25% of the mixture by weight. Other exemplary additives may include one or more of organic pigments, inorganic pigments, white pigments, special effect pigments, aluminum pigments, or other pigments. Organic pigments may be used for applications needing high tinting strength and brilliant shades. Inorganic pigments may have qualities such as being easy dispersing, heat stable, lightfast, weatherable, opaque, or insoluble. Carbon black may have excellent color strength, cost-effectiveness, and ultraviolet performance. In addition, carbon black may impart stability against UV radiation and electrical conductivity to plastics. White pigments may be derived from Titanium Dioxide, and may be efficient at scattering visible light and imparting whiteness, brightness, and high opacity when incorporated into a plastic formulation. Aluminum pigments may provide a one or more of a variety of effects to plastics, including glitter, high sparkle, metallescent, pinpoint sparkle, and liquid metal. Some other exemplary pigments usable with the methods in this disclosure include fluorescent, photochromic, and thermochromic pigments.

Three main categories of organic pigments that may be used include polycyclic, Azo, and metal complexes. Exemplary pigments may include one or more of (e.g., one or combinations of) Anthraquinone, Benzimidazolone, BONA Lake, Diazo pigments, Diketo pyrrolo pyrrole (DPP), Isoindolinone, Mono Azo salts, Naphthol Lake, Phthalocyanine, Quinacridone. Inorganic pigments may include C.I. Pigment Yellow 42 (Iron oxide), C.I. Pigment Yellow 34 (Lead chromates), C.I. Pigment Yellow 184 (Bismuth Vanadates), or C.I. Pigment Yellow 53 (Nickel antimony), C.I. Pigment Orange 20 (Cadmium Sulfide), C.I. Pigment Brown 6 (Iron oxide), C.I. Pigment Brown 29 (Chrome/Iron oxide), C.I. Pigment Brown 31 (Chrome/Iron oxide), C.I. Pigment Brown 33 (Chrome/Iron oxide), C.I. Pigment Red 101 (Iron oxide), C.I. Pigment Red 104, (Mixed Phase Pigment), C.I. Pigment Red 29 (Ultramarine pigment), C.I. Pigment Blue 29, (Ultramarine Pigment), C.I. Pigment Blue 28, (metal oxyde), C.I. Pigment Blue 36 (metal oxyde), C.I. Pigment Violet 15 (Ultramarine Pigment), C.I. Pigment Violet 16 (Manganese violet), Pigment Green 17 (Chrome Oxide Green), C.I. Pigment Green 19, (Cobalt-based mixed metal oxides), C.I. Pigment Green 26 (Cobalt-based mixed metal oxides), and C.I. Pigment Green 50 (Cobalt-based mixed metal oxides). In some embodiments, a fabric reactive dye may also be added to the mixture.

In various embodiments, after the proper mixture is achieved, the mixture is then sieved to ensure the proper distribution of particles for optimal printing and to avoid the presence of unwanted clumps. In some examples, the particle size (e.g., a greatest particle dimension) is preferably 200 microns or less after sieving. In other embodiments, the particle size is less than 50, 100, 150, 250, 300, 350, or 400 microns. In various embodiments, further sieving or other steps may be used to achieve uniformity of particle sizes, such as particles that are within a range of 5, 10, 15, 20, 25, 50, 100, or 150 microns of each other in size.

The mixture may then be analyzed to determine a proper printing temperature range, and differential scanning colorimetry may be used to analyze the mixture. For example, Rowak based powders may have melting temperatures ranging from 80-120° C., which may be useful for embodiments that use lasers that are more compact, use less energy, are lower cost, are more portable, lower weight, or have lower power capabilities than some other lasers. Nylon-6 or other higher temperature powders, by contrast, may have a melting temperature of approximately 170° C. which may be useful for use with embodiments using higher powered, commercial-grade lasers.

After the appropriate printing temperature range is achieved, the mixture may then be sintered using a laser configured to generate infrared rays at a wavelength of between 795-815 nm to print or otherwise generate the external embellishment 200. The external embellishments 200 are generally self-supporting during the additive manufacturing, and may not require scaffolding or other support structures. For some embodiments, use of support structures may provide additional benefits.

The SLS printing process is a powerful 3D printing technology that produces highly accurate and durable parts that are capable of being used directly in end-use, low-volume production, or for rapid prototyping. Stated generally, selective laser sintering is an additive manufacturing (AM) technique that utilizes a laser (e.g., a carbon dioxide laser, a high-power laser) to fuse small particles of plastic powders into a mass that has a desired three-dimensional shape, such as external embellishment 200, a jacket, a shirt, a shoe, a shoe component, a sole, a shoe tongue, or a shoe heel. More specifically, powder particles may be taken from a powder delivery system wherein a piston advances the powder particles, which are then moved to a fabrication powder bed via a roller. The laser may selectively fuse the powdered particles by scanning cross-sections generated from a 3D digital description of the part (for example, which may originate from a computer aided drafting (CAD) file or scanned data) on the surface of the powder bed. After each cross-section is scanned, the powder bed is lowered by one layer of thickness via a fabrication piston or other suitable device, and a new layer of powdered material is applied on top of the previous layer, and the process is repeated until the part is completed (i.e., all of the individual layers of the external embellishment 200 have been applied).

While or after printing the sintered material, the manufactured external embellishment 200 may be bonded to a substrate such as a fabric, a soft good, rubber, metal, plastic, concrete, or wood. A fabric or soft good may include one or more of cotton, polyester, mixed fabrics, etc. The bonding may be accomplished at a relatively low pressure, such as between 2-5 psi, and a relatively low heat, such as between 115-130° C. In other embodiments, bonding may be performed at different pressure ranges such as: 0-2 psi, 1-7 psi, 7-10 psi, 10-12 psi, 12-18 psi, 18-21 psi, 21-50 psi, 50-100 psi, or 100-150 psi. In some embodiments, use of pressures below standard atmospheric pressure (e.g., 14.696 psi) may result in a more stable melt pool and reduced porosity.

Additionally, the external embellishments 200 may not require additional processing before bonding (other than air blowing of the parts after printing), and bonded external embellishments 200 may be capable of withstanding at least four washing cycles (e.g., at 60° C. and 50 minutes of drying). Additionally, a printing thickness of lower than 0.5 mm can be achieved using aforementioned current powder formulations. The external embellishments 200 may also be manufactured to be chemical resistant to common solvents, such as, but not limited to, bleach, ammonia, acetone, toluene, heptane, deionized water, and isopropyl alcohol.

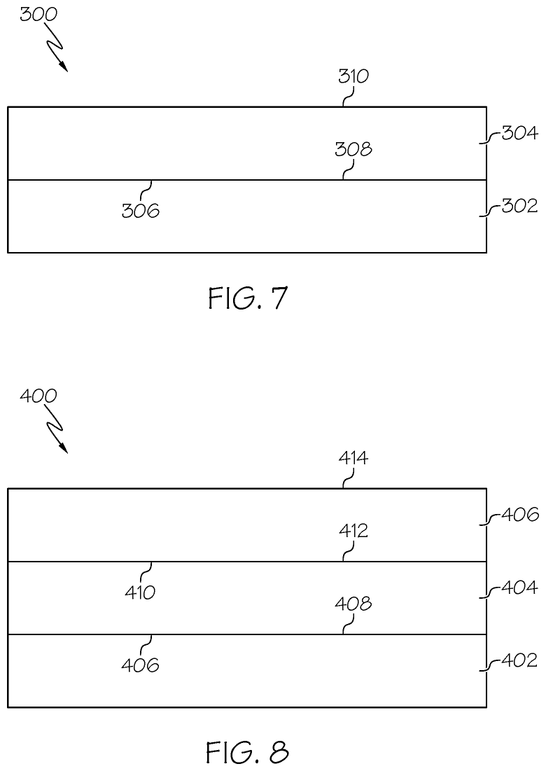

As shown in FIG. 7, an embellished article 300 may be created when a first embellishment part 304 is formed on top of a substrate 302. The first embellishment part 304 may be formed using selective laser sintering (or other additive manufacturing techniques) to heat and/or melt a powder (e.g., a powder formed from plastic, glass, ceramic, or metal) such that the melted material of the first side 308 of the first embellishment part 304 penetrates into the first side 306 of the substrate, such as between fibers, into cracks or voids, into indentations, or around protrusions on the surface of the substrate 302. As discussed above, the substrate 302 may compose part or all of a clothing article, and the second side 310 of the first embellishment part 304 may be visible to a viewer, such as a consumer. In this way, part or all of an embellishment 300 may be formed and bonded without necessarily utilizing stitching, sonic welding, or thermal bonding.

The additive manufacturing of FIG. 7 may be performed below a temperature threshold and/or below a pressure threshold. In some embodiments, the temperature threshold may be below 115° C., 130° C., 178° C.-180° C., 220° C., or 280° C. In some embodiments, melting and/or bonding may occur between 115-130° C. or between 178° C.-180° C. In some embodiments, the pressure during manufacturing may be between 0-2 psi, 1-7 psi, 7-10 psi, 10-12 psi, 12-18 psi, 18-21 psi, 21-50 psi, 50-100 psi, or 100-150 psi. The pressure threshold may thus be 2 psi, 7 psi, 10 psi, 12 psi, 18 psi, 21 psi, 50 psi, 100 psi, or 150 psi.

As shown in FIG. 8, an embellished article 400 may be formed using multiple operations discussed below. A first embellishment part 404 may be created by forming a first embellishment part 404 on top of a substrate 402. The first embellishment part 400 may be formed using selective laser sintering (or other additive manufacturing techniques) to heat and/or melt a powder (e.g., a powder formed from plastic, glass, ceramic, or metal) such that the melted material of the first side 408 of the first embellishment part 404 penetrates into the first side 406 of the substrate, such as between fibers, into cracks or voids, into indentations, or around protrusions on the surface of the substrate 402. As discussed above, the substrate 402 may compose part or all of a clothing article.

Formation of the embellished article 400 may continue by forming a second embellishment part 406 (e.g., an additional embellishment part), such as by using an additive manufacturing method. The second embellishment part 406 may be bonded to the first embellishment part 404 by additively manufacturing the second embellishment part 406 on top of the first embellishment part 404. This may also result in bonding between the two parts when at least a portion of a first surface 412 of the second embellishment part 406 adheres or melts into or otherwise combines with the second surface 410 of the first embellishment part 404. In other embodiments, an adhesive is used to bond the second surface 410 of the first embellishment part 404 to the first surface 412 of the second embellishment part 406. Other methods of attachment such as using an adhesive, fastener, or other attachment mechanism may also be used. In this way, materials and or components that would ordinarily have required sonic welding, stitching, or thermal bonding to be attached to the substrate (e.g., a fabric, a soft material, a clothing article, a toy, etc.) can be attached through the first embellishment part to the substrate. The second side 414 of the second embellishment part may be exposed externally on top of a clothing article, and may be visible to a viewer such as a consumer.

The additive manufacturing of FIG. 8 may be performed below a temperature threshold and/or below a pressure threshold. In some embodiments, the temperature threshold may be below 115° C., 130° C., 178° C.-180° C., 220° C., or 280° C. In some embodiments, melting and/or bonding may occur between 115-130° C. or between 178° C.-180° C. In some embodiments, the pressure during manufacturing may be between 0-2 psi, 1-7 psi, 7-10 psi, 10-12 psi, 12-18 psi, 18-21 psi, 21-50 psi, 50-100 psi, or 100-150 psi. The pressure threshold may thus be 2 psi, 7 psi, 10 psi, 12 psi, 18 psi, 21 psi, 50 psi, 100 psi, or 150 psi.

### Optimizing Print Conditions

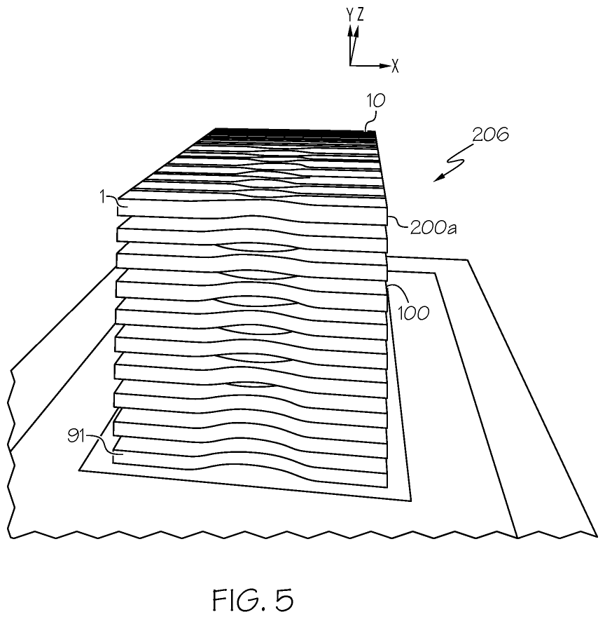

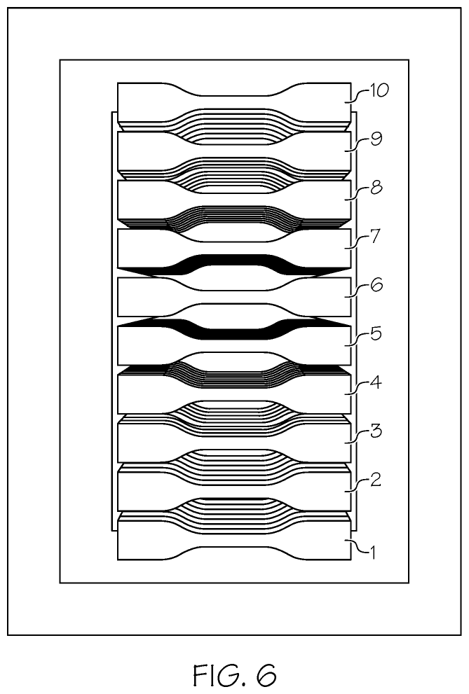

A method of optimizing print conditions for a plurality of printable external embellishments 200 is also disclosed. More specifically, the method begins by selecting a low-temperature thermoplastic powder and mixing it with an additive in the aforementioned manner. The resulting mixture is then sieved, and an appropriate printing temperature range is determined. The mixture is then sintered to additively manufacture a test bed matrix 206 of the external embellishments 200, as best illustrated in FIGS. 5 and 6.

Once the test bed matrix 206 of the external embellishments 200 has been created, the elongation and tensile strength of each external embellishment 200 can be measured. Based on the measurements, an optimal print position within the print bed matrix 206 can then be determined, as more fully explained below. In an alternative embodiment, the method of optimizing print conditions may further comprise determining a thickness of each external embellishment 200 based on its print position within the print bed matrix 206, and/or determining the chemical resistance of each external embellishment 200 based on its print position within the print bed matrix 206.

In one example of the method of the present disclosure, a mixture of Rowak-35-80 powder with 2% graphite was tested. More specifically and as illustrated in FIG. 1, one hundred ATSM Type-5 dog bones were printed, each having a length (L) and a width (W) to investigate how different printing positions within a print bed matrix 206 affect the mechanical properties of the printed dog bone. The ATSM D638 was utilized to test the dog bones (Standard Test Method for Tensile Properties of Plastics). As illustrated in FIGS. 5 and 6, dog bones 1-10 are the test specimens with the highest Y-value (height), and were the dog bones printed last. Also, specimens that end in the number “1” are the dog bones that were printed closest to the front of the print bed 202, specimens that end in “5” were printed in the middle, and specimens that end in “0” were printed at the back of the print bed 202.

The average percent elongation and tensile strength were observed as having a 456% average elongation with a standard deviation of 7.55%, and a 465.971 PSI average tensile strength with a standard deviation of 14.85%. Compared to high temperature plastics, such as Nylon-6 (Tensile: 7,000 PSI, Elongation: 90%), the elongation is significantly higher with a lower tensile strength. In this experiment, every sample is uniquely different since it has different XYZ coordinates (i.e. not printed in the same space). Thus, the data indicates that if the experiment were repeated, around 70% of the printed samples would have an elongation value which is within 7.55% of the average elongation value (456%), and a tensile strength value which is within 14.85% of the average tensile strength value (466 PSI).

From test results, as the print reached the middle rows, dog bones 51-70 show the highest precision (lowest standard deviation). However, dog bones printed at the start of the print, namely bones 91-100, and dog bones at the end of the print, namely bones 1-10, have the least amount of precision. This information is useful to determine where to place a part, such as external embellishment 200, within the print bed matrix 206. For example, if it is desirable to print external embellishments 200 with high precision, placing them near the same position as dog bones 51-70 would give the greatest control over precision in terms of elongation or tensile strength.

From test results, the dog bones that end in “8” and “4” have the greatest precision in terms of elongation (i.e., the lowest standard deviation), while the dog bones ending in “6” and “9” have the lowest precision. The tensile strength trend is almost the opposite of the elongation trend with dog bones ending in “4” being the most precise in terms of both elongation and tensile.

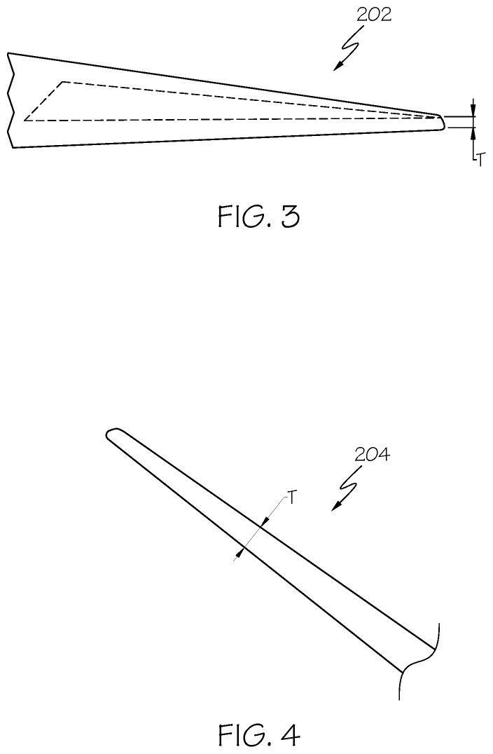

Additional testing included investigating how thin an external embellishment 200 may be printed. As illustrated in FIG. 2, the external embellishment 200 comprises a first portion 202 highlighted in section B, and a second portion 204 highlighted in section A. The thickness of the files were changed from a thickness of 2 mm-0.4 mm and were measured using a TMI machine, calipers, and microscopy. When looking at the STL (Standard Tessellation Language or Stereolithography) file, the thickness T of the tip the first portion 202, illustrated in FIG. 3, was supposed to be 0.25 mm but was measured to be 0.453 mm (an increase of 1.81%). Similarly, the thickness T of the second portion 204, illustrated in FIG. 4, ranged from 0.453 mm-1.147 mm indicating low precision and accuracy of the measuring methods.

Additionally, in order to understand how to clean the external embellishments 200 and investigate chemical resistance, several common lab solvents were used as discussed supra. After printing, the external embellishments 200 were submerged in specific solvents and rolled for two hours. The external embellishments 200 were then air dried followed by baking in a 60° C. oven for 30 minutes. While samples initially exposed to toluene and isopropyl alcohol curled, the curling went away after both air and heat drying. Additionally, the external embellishments 200 exposed to ammonia had a darker color indicating chemical etching.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. In addition, the term “one or more of a, b, and c”, “at least one of a, b, and c”, and “at least one of a, b, or c” is intended to refer to a, b, c, or combinations thereof including a and b, b and c, a and c, or a, b, and c.

1. A method of manufacturing comprising:
forming and attaching a first embellishment part onto a substrate composing a clothing article by sintering a thermoplastic powder on the substrate,
wherein sintering occurs at a temperature below a temperature threshold, and sintering occurs at a pressure below a pressure threshold.

2. The method of claim 1, wherein the first embellishment part comprises all structural components of an entire embellishment.

3. The method of claim 1, wherein the first embellishment part is a foundation for a complete embellishment.

4. The method of claim 1, further comprising forming a second embellishment part using an additive manufacturing process.

5. The method of claim 4, wherein forming the second embellishment part using the additive manufacturing process comprises bonding the first embellishment part and the second embellishment part, and wherein the additive manufacturing process is different from sintering.

6. The method claim 1, further comprising:
mixing a low-temperature thermoplastic powder with an additive to form a mixture; and
sieving the mixture.

7. The method claim 1, wherein the low-temperature thermoplastic powder is a polyurethane or a polyamide.

8. The method of claim 6, wherein the additive comprises graphite or carbon black.

9. The method of claim 6, wherein the additive is 2-10% of the mixture.

10. The method claim 1, wherein the mixture is sintered using a laser configured to generate an infrared ray at a wavelength of 795 nm to 815 nm.

11. The method claim 1, wherein the thermoplastic powder is limited to particles having a greatest dimension of 200 microns or less.

12. The method of claim 1, wherein the thermoplastic powder has a melting temperature of 80° C. to 120° C.

13. The method claim 1, wherein the substrate is fabric.

14. The method claim 1, wherein the first embellishment part is printed in a configuration selected from the group comprising: a numerical indicia, an alphabetical indicia, an alphanumeric indicia, a logo, an insignia, a geometric shape, and a non-geometric shape.

15. An additively manufactured embellishment part comprising:
a substrate composing a clothing article;
a first embellishment part formed and attached to the substrate by sintering a thermoplastic powder on the substrate,
wherein sintering occurred at a temperature below a temperature threshold, and sintering occurred at a pressure below a pressure threshold.

16. The embellishment part of claim 15 further comprising adding a fabric reactive dye to the mixture.

17. The embellishment part of claim 15, wherein the mixture is sieved to achieve a particle size of 200 micron or less.

18. The embellishment part of claim 15, wherein the thermoplastic powder comprises an additive is graphite or carbon black.

19. The embellishment part of claim 18, wherein the additive is graphite or carbon black.

20. The embellishment part of claim 18, wherein the additive is 0.5-10% of the mixture.

21. The embellishment part claim 15, wherein the first embellishment part is self-supporting during printing.

22. The embellishment part of claim 15, wherein the first embellishment part is bonded to a fabric at a temperature of 115° C. to 130° C.

23. A method of optimizing print conditions for a plurality of external embellishments comprising:
mixing a thermoplastic powder with an additive to form a mixture;
sintering the mixture to additively manufacture a test bed matrix of the plurality of external embellishments;
analyzing each of the plurality of external embellishments; and
determining an optimal print position within the test bed matrix.

24. The method of claim 23, wherein the analysis of each of the plurality of external embellishments comprises at least one of (a) measuring elongation, (b) calculating tensile strength, (c) determining thickness, and (d) determining chemical resistance.
